(19) United States
(12) Patent Application Publication
(10) Pub. No.: US 2012/0167464 A1
(43) Pub. Date: Jul. 5, 2012

(54) PLASMA-ASSISTED CATALYTIC REFORMING APPARATUS AND METHOD

(75) Inventors: CHAO-YUH CHEN, Hsinchu County (TW); Hung-Tsai Hu, Taipei County (TW); Yu Chao, Taoyuan County (TW); Wai-Ting Huang, Taipei County (TW)

(73) Assignee: Institute of Nuclear Energy Research Atomic Energy Council, Executive Yuan, Taoyuan County (TW)

(21) Appl. No.: 12/982,084

(22) Filed: Dec. 30, 2010

(51) Int. Cl. C10K 3/04; B01J 19/08

(52) U.S. Cl. 48/102 A; 48/213; 48/197 FM

(57) ABSTRACT

A plasma-assisted catalytic reforming apparatus includes a feeder, a plasma reactor, a reforming reactor and a pre-heater. A first reforming cavity of the reforming reactor is connected to a plasma cavity of the plasma reactor, and the reforming reactor is inside a pre-heating cavity of the pre-heater. A pre-heating pipe of the pre-heater is connected between a mixing room of the feeder and the plasma cavity and partially disposed inside the pre-heating cavity. The first reforming cavity is inside a second reforming cavity of the reforming reactor. An end of a recirculation pipe of the reforming reactor is connected to a first reforming cavity opening of the first reforming cavity and partially disposed inside the first reforming cavity. Another end of the recirculation pipe passes a second reforming cavity outlet of the second reforming cavity and partially disposed inside the pre-heating cavity. A plasma-assisted catalytic reforming method is also provided.

### BACKGROUND OF THE INVENTION

1. Field of Invention

The present invention relates to a catalytic reforming apparatus and method, and more particularly to a plasma-assisted catalytic reforming apparatus and method.

2. Related Art

With the development of science and technology, available energy becomes more and more diversified. Especially, fossil fuel or biomass fuel can be converted into hydrogen fuel in a catalytic reforming mode. Generally speaking, a hydrocarbon gas or hydrocarbon liquid such as natural gas, ethanol, methane, and butane can be converted into hydrogen fuel through catalytic reforming at a high temperature. The hydrogen fuel is regarded as an environment friendly fuel.

A conventional catalytic reforming apparatus has to heat a catalyst bed first by using an auxiliary burner or an electric heater. After the catalyst bed reaches a work temperature, heated hydrocarbon gas and air are fed for partial oxidation reforming reaction to be converted into hydrogen. The temperature of the catalyst bed is maintained by using the heat generated from the partial oxidation reforming reaction, such that the auxiliary burner or electric heater can be turned off.

However, the auxiliary burner or electric heater is usually a large-volume and very dangerous member, which is only used for heating the catalyst bed first and has very low efficiency in use.

Another conventional catalytic reforming apparatus is used for reforming the hydrocarbon liquid, which mainly heats the hydrocarbon liquid and water with a boiler to vaporize them into high-temperature gas, so as to perform reforming reactions with the heat catalyst bed. Therefore, the catalytic reforming apparatus has to heat the hydrocarbon liquid and water by operating the boiler continuously. However, the boiler has very low efficiency for heating, causing high energy consumption. In addition, the boiler is usually also a large-volume and dangerous member.

Moreover, a plasma-assisted catalytic reforming apparatus is also provided in the prior art, which generates a high-voltage high-frequency alternating current by using a plasma reactor to generate discharge to heat the hydrocarbon gas and air, so that the hydrocarbon gas and air that become plasma heat the catalyst bed to a work temperature, so as to realize the reforming reaction. When the temperature of the catalyst bed reaches an upper threshold value, the plasma reactor can be powered off. When the temperature of the catalyst is lowered to a lower threshold value, the plasma reactor is powered on again.

Additionally, U.S. Pat. Nos. 6,702,991, 6,804,950, and 6,506,359 are slightly improved based on the prior art. However, for both the hydrocarbon gas and the hydrocarbon liquid, an additional heating appliance needs to be arranged to heat the catalyst bed to the work temperature, so that the catalytic reforming apparatus has a very large integral volume and is also very dangerous. Moreover, heating efficiency of the heating appliance is unsatisfactory and much energy is wasted in the process of heat exchange with the catalyst bed.

### SUMMARY OF THE INVENTION

In view of this, an objective of the present invention is to provide a plasma-assisted catalytic reforming apparatus, in which a high-temperature reforming reactor is enclosed in a pre-heater, and a recirculation pipe is arranged to guide a heat source, so as to utilise a heat source effectively and reduce a volume of the catalytic reforming apparatus greatly.

In addition, another objective of the present invention is to provide a plasma-assisted catalytic reforming method. A hydrocarbon liquid is atomized first, and the hydrocarbon liquid is then heated and vaporized. As the atomized hydrocarbon liquid has large surface areas, the heating efficiency can be greatly increased.

In order to achieve the above or other objectives, the present invention provides a plasma-assisted catalytic reforming apparatus, which includes a feeder, a plasma reactor, a reforming reactor, and a pre-heater. The reforming reactor is connected to the plasma reactor. The feeder has a mixing room. The plasma reactor includes a plasma cavity, a plasma electrode, and a plasma power supply unit. The plasma cavity has a plasma cavity inlet and a plasma cavity outlet. The plasma power supply unit is coupled to the plasma cavity and the plasma electrode, so as to generate discharge inside the plasma cavity. The reforming reactor includes a first reforming cavity, a second reforming cavity, a recirculation pipe, a porous plate, and a first catalyst bed. The first reforming cavity has a first reforming cavity inlet, a first reforming cavity outlet, and a first reforming cavity opening. The first reforming cavity inlet is connected to the plasma cavity outlet. The first reforming cavity is disposed inside the second reforming cavity, and the second reforming cavity has a second reforming cavity outlet. The recirculation pipe is partially disposed inside the first reforming cavity. An end of the recirculation pipe is connected to the first reforming cavity opening, and another end of the recirculation pipe passes through the second reforming cavity outlet through the first reforming cavity outlet. The porous plate is disposed inside the first reforming cavity and is adjacent to the first reforming cavity inlet. The first catalyst bed is disposed inside the first reforming cavity and the second reforming cavity. The pre-heater includes a pre-heating cavity and a pre-heating pipe. The reforming reactor is disposed inside the pre-heating cavity. The pre-heating cavity has a pre-heating cavity inlet and a pre-heating cavity outlet. The pre-heating pipe is disposed inside the pre-heating cavity and surrounds the reforming reactor. An end of the pre-heating pipe is connected to the plasma cavity inlet, and another end of the pre-heating pipe passes through the pre-heating cavity inlet and is connected to the mixing room.

In order to achieve the above or other objectives, the present invention further provides a plasma-assisted catalytic reforming method, which includes the following steps. A piezoelectric atomizer unit is provided to atomize hydrocarbon liquid and water. Air is provided. The air and the atomized hydrocarbon liquid and water are mixed, and the atomized hydrocarbon liquid and water are vaporized. A plasma reactor is provided to excite the air and the vaporized hydrocarbon liquid and water into quasi-neutral mixed gas. A reforming reactor is provided to reform the quasi-neutral mixed gas into high-temperature reaction gas and reform the high-temperature reaction gas into high-temperature reformed gas. The high-temperature reformed gas is suitable for heating the atomized hydrocarbon liquid and water, so that the atomized hydrocarbon liquid and water are vaporized.

In an embodiment of the present invention, the air and the hydrocarbon gas are mixed in the mixing room and enter the plasma cavity along the pre-heating pipe to become the quasi-neutral mixed gas. The quasi-neutral mixed gas enters the first reforming cavity and is reformed in the first catalyst bed to form high-temperature reaction gas. The high-temperature reaction gas enters the second reforming cavity through the first reforming cavity outlet and is reformed in the first catalyst bed to form the high-temperature reformed gas. The high-temperature reformed gas enters the recirculation pipe through the first reforming cavity opening, enters the pre-heating cavity along the recirculation pipe to heat the air and hydrocarbon gas inside the pre-heating pipe, and leaves the pre-heating cavity through the pre-heating cavity outlet.

In an embodiment of the present invention, the feeder further has a first regulating valve and a second regulating valve. The first regulating valve and the second regulating valve are connected to the mixing room, so as to control flow amounts of the air and the hydrocarbon gas that enter the mixing room respectively.

In an embodiment of the present invention, a portion of the recirculation pipe inside the first reforming cavity is, for example, a coil pipe.

In an embodiment of the present invention, an end of the pre-heating pipe is connected to the plasma cavity inlet in a direction, for example, deviating from a center of the plasma cavity.

In an embodiment of the present invention, the pre-heater further includes a spiral pre-heating channel, which is disposed inside the pre-heating cavity and connected between an end of the pre-heating pipe and the plasma cavity inlet.

In an embodiment of the present invention, the reforming reactor further includes a first partition plate and a second partition plate. The first partition plate is disposed inside the first reforming cavity and the second partition plate is disposed inside the second reforming cavity. The first partition plate may be a cross partition plate or a #-shaped partition plate.

In an embodiment of the present invention, the pre-heater further includes a third partition plate. The third partition plate is disposed inside the pre-heating cavity, so as to divide the pre-heating cavity into a first pre-heating area and a second pre-heating area that are connected. In addition, the pre-heating pipe surrounds the reforming reactor in two layers along the first pre-heating area and the second pre-heating area. Additionally, the pre-heater further includes a second catalyst bed, a third catalyst bed, and a fourth catalyst bed. The second catalyst bed is disposed inside the first pre-heating area, the third catalyst bed is disposed at a border between the first pre-heating area and the second pre-heating area, and the fourth catalyst bed is disposed inside the second pre-heating area. The second catalyst bed has a high-temperature water-gas shift catalyst, the third catalyst bed has a low-temperature water-gas shift catalyst, and the fourth catalyst bed has a carbon monoxide (CO) preferential oxidation catalyst.

In an embodiment of the present invention, the feeder further has a piezoelectric atomizer unit. The piezoelectric atomizer unit is connected to the mixing room. The hydrocarbon liquid and water form atomized hydrocarbon liquid and water in the piezoelectric atomizer unit. The atomized hydrocarbon liquid and water enter the mixing room, and enter the pre-heating pipe after being mixed with air that enters the mixing room. The atomized hydrocarbon liquid and water form vaporized hydrocarbon liquid and water inside the pre-heating pipe, and enter the plasma cavity together with the air along the pre-heating pipe to become quasi-neutral mixed gas. The quasi-neutral mixed gas enters the first reforming cavity, and is reformed into high-temperature reaction gas in the first catalyst bed. The high-temperature reaction gas enters the second reforming cavity through the first reforming cavity outlet, and is reformed into high-temperature reformed gas in the first catalyst bed. The high-temperature reformed gas enters the recirculation pipe through the first reforming cavity opening, enters the pre-heating cavity along the recirculation pipe to heat the air, the atomized hydrocarbon liquid, and the atomized water inside the pre-heating pipe, and leaves the pre-heating cavity through the pre-heating cavity outlet.

In an embodiment of the present invention, the hydrocarbon liquid is, for example, ethanol or liquefied petroleum gas.

In an embodiment of the present invention, the feeder further includes a first regulating valve, a third regulating valve, and a fourth regulating valve. The first regulating valve is connected to the mixing room to control an air flow amount. The third regulating valve and the fourth regulating valve are connected to the piezoelectric atomizer unit, to control flow amounts of the hydrocarbon liquid and water respectively.

In an embodiment of the present invention, the pre-heating cavity further includes a pre-heating cavity opening, so that the air enters the pre-heating cavity through the pre-heating cavity opening. In addition, the feeder further includes a fifth regulating valve, and the fifth regulating valve is connected to the pre-heating cavity opening to control an air flow amount.

In conclusion, in the plasma-assisted catalytic reforming apparatus and method of the present invention, through the recirculation pipe, a temperature of the catalyst beds can be evenly distributed and the air and hydrocarbon gas can evenly flow through the porous catalyst and be utilized fully, so as to reduce a volume of the plasma-assisted catalytic reforming apparatus and increase efficiency of reforming the hydrocarbon gas into hydrogen.

In order to make other objectives, features, and advantages of the present invention more comprehensible, the present invention is illustrated below in detail with reference to the preferred embodiments and the accompanying drawings.

### BRIEF DESCRIPTION OF THE DRAWINGS

The present invention will become more fully understood from the detailed description given herein below for illustration only, and thus are not limitative of the present invention, and wherein:

FIG. 1A is a schematic sectional view of a plasma-assisted catalytic reforming apparatus according to an embodiment of the present invention;

FIG. 1B is a schematic sectional view of the plasma-assisted catalytic reforming apparatus in FIG. 1A with a first catalyst bed being omitted;

FIG. 2A is a schematic sectional view of a plasma-assisted catalytic reforming apparatus according to another embodiment of the present invention;

FIG. 2B is a sectional top view of a reforming reactor in FIG. 2A along line AA;

FIGS. 2C to 2D are sectional top views of two reforming reactors according to another embodiment of the present invention;

FIG. 3A is a schematic sectional view of a plasma-assisted catalytic reforming apparatus according to another embodiment of the present invention;

FIG. 3B is a sectional top view of a spiral pre-heating channel in FIG. 3A along line BB;

FIG. 4 is a schematic sectional view of a plasma-assisted catalytic reforming apparatus according to another embodiment of the present invention;

FIG. 5A is a schematic sectional view of a plasma-assisted catalytic reforming apparatus according to another embodiment of the present invention;

FIG. 5B is a schematic sectional view of the plasma-assisted catalytic reforming apparatus in FIG. 5A with a second catalyst bed, a third catalyst bed, and a fourth catalyst bed being removed; and

FIG. 6 is a schematic flow chart of a plasma-assisted catalytic reforming method according to an embodiment of the present invention.

### DETAILED DESCRIPTION OF THE INVENTION

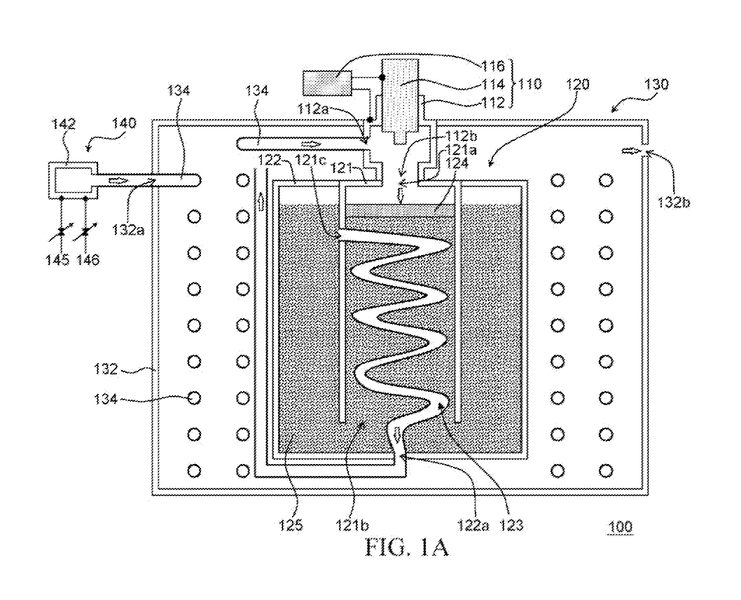

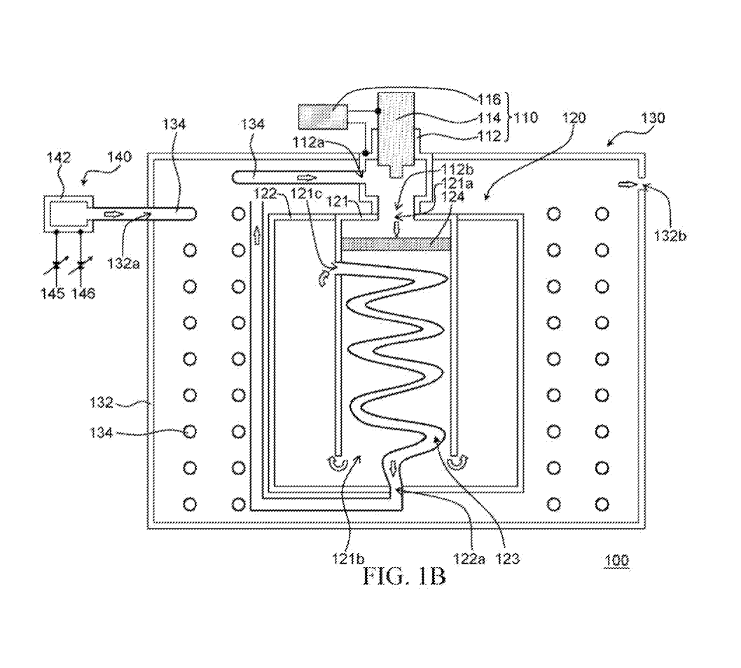

FIG. 1A is a schematic sectional view of a plasma-assisted catalytic reforming apparatus according to an embodiment of the present invention. FIG. 1B is a schematic sectional view of the plasma-assisted catalytic reforming apparatus in FIG. 1A with a first catalyst bed being omitted. Referring to FIGS. 1A to 1B, a plasma-assisted catalytic reforming apparatus 100 of the present invention includes a plasma reactor 110, a reforming reactor 120, a pre-heater 130, and a feeder 140. Complicated connections among the members are the spirit of the present invention, which achieve the objectives of increasing the reforming efficiency and heat source use efficiency. Each member and the connection relation thereof are introduced respectively, and then the detailed reforming process of the present invention is illustrated.

The plasma reactor 110 includes a plasma cavity 112, a plasma electrode 114, and a plasma power supply unit 116. The plasma power supply unit 116 is coupled to the plasma cavity 112 and the plasma electrode 114. By supplying a high-voltage high-frequency alternating current, an arc discharge is generated inside the plasma cavity 112, so as to ionize gas inside the plasma cavity 112 (the gas is mixed gas of air, hydrocarbon gas or vaporized hydrocarbon liquid, which will be described in detail later).

In addition, the plasma cavity 112 has a plasma cavity inlet 112a and a plasma cavity outlet 112b. The gas enters the plasma cavity 112 through the plasma cavity inlet 112a and leaves the plasma cavity 112 through the plasma cavity outlet 112b after being ionized. The plasma reactor 110 is connected to the reforming reactor 120, so that the gas that leaves from the plasma cavity 112 enters the reforming reactor 120.

The reforming reactor 120 includes a first reforming cavity 121, a second reforming cavity 122, a recirculation pipe 123, a porous plate 124, and a first catalyst bed 125. The first reforming cavity 121 is disposed inside the second reforming cavity 122. The first catalyst bed 125 is disposed inside the first reforming cavity 121 and the second reforming cavity 122.

In this embodiment, both the first reforming cavity 121 and the second reforming cavity 122 are in a drum shape. Center lines of the first reforming cavity 121 and the second reforming cavity 122 overlap and align with a center line of the plasma cavity 112 to facilitate assembly and operation. However, the shapes of the first reforming cavity 121 and the second reforming cavity 122 are not limited in the present invention.

In addition, the first reforming cavity 121 further has a first reforming cavity inlet 121a and a first reforming cavity outlet 121b opposite to each other. The first reforming cavity inlet 121a is connected to the plasma cavity outlet 112b, so that the ionized gas enters the first reforming cavity inlet 121a through the first reforming cavity inlet 121a and has a reforming reaction with the first catalyst bed 125. Next, the gas enters the second reforming cavity 122 through the first reforming cavity outlet 121b, and continues the reforming reaction with the first catalyst bed 125.

Also, according to a flow direction of the gas in the first catalyst bed 125, the first catalyst bed 125 can be approximately divided into a reforming reaction anterior segment disposed inside the first reforming cavity 121 and adjacent to the reforming cavity inlet 121a, a reforming reaction middle segment disposed at a border between the first reforming cavity 121 and the second reforming cavity 122, and a reforming reaction posterior segment disposed inside the second reforming cavity 122 and adjacent to the reforming cavity inlet 121a. Definitely, the first catalyst bed 125 is divided into three segments only for ease of illustration, and in practice, the reforming reaction process keeps consistent.

In order to ensure even distribution of the gas after the gas enters the first reforming cavity 121 through the first reforming cavity inlet 121a, in the present invention, the porous plate 124 can be disposed inside the first reforming cavity 121 and adjacent to the first reforming cavity inlet 121a. Therefore, through the dispersion effect of the porous plate 124, the gas can pass through the porous plate 124 evenly to react with the first catalyst bed 125.

Generally speaking, after the gas passes through the porous plate 124, due to the geometric arrangement of the first reforming cavity 121 and the second reforming cavity 122, the gas is still unable to pass through the first catalyst bed 125 in a completely even mode. Instead, the gas reaches the first reforming cavity outlet 121b through the first catalyst bed 125 in a shortest path. The phenomenon is usually referred to as the flow-short-circuit or channeling effect, so that the gas contacts the least catalyst in the flowing process.

In order to eliminate the disadvantage, in the present invention, a first reforming cavity opening 121c is further opened in the first reforming cavity 121, and a second reforming cavity outlet 122a is further opened in the second reforming cavity 122. The first reforming cavity opening 121c may be opened in an area of the reforming reaction posterior segment of the first catalyst bed 125, and the second reforming cavity outlet 122a is adjacent to the first reforming cavity outlet 121b and may be opened in an area of the reforming reaction middle segment of the first catalyst bed 125.

The recirculation pipe 123 is partially disposed inside the first reforming cavity 121. An end of the recirculation pipe 123 is connected to the first reforming cavity opening 121c. Another end of the recirculation pipe 123 passes through the second reforming cavity outlet 122a through the first reforming cavity outlet 121b. A portion of the recirculation pipe 123 inside the first reforming cavity 121 can be regarded as an obstacle to prevent the gas from passing through the area of the reforming reaction anterior segment of the first catalyst bed 125 in the shortest path mode.

In such a manner, the gas passes through the area of the reforming reaction anterior segment of the first catalyst bed 125 in a relatively long path, so as to contact more catalyst to increase the efficiency of the reforming reaction. In addition, a portion of the recirculation pipe 123 inside the first reforming cavity 121 may be a coil pipe, which presents irregular arrangement, so as to avoid the flow-short-circuit problem.

Referring to FIGS. 1A and 1B again, the pre-heater 130 includes a pre-heating cavity 132 and a pre-heating pipe 134. The reforming reactor 120 is disposed inside the pre-heating cavity 132, and the pre-heating cavity 132 has a pre-heating cavity outlet 132b. After flowing to the area of the reforming reaction posterior segment of the first catalyst bed 125, the gas flows into the recirculation pipe 123 through the first reforming cavity opening 121c, and flows out from the reforming reactor 120 along the recirculation pipe 123 to enter the pre-heating cavity 132. The whole pre-heating cavity 132 is eventually filled with the gas after the reforming reaction, which is collected and utilised from the pre-heating cavity outlet 132.

In addition, the pre-heating cavity 132 further has a pre-heating cavity inlet 132a. The pre-heating pipe 134 is disposed inside the pre-heating cavity 132 and surrounds the reforming reactor 120. Additionally, an end of the pre-heating pipe 134 is connected to the plasma cavity inlet 112a, and another end of the pre-heating pipe 134 passes through the pre-heating cavity inlet 132a to be connected to the mixing room 142 of the feeder 140. In such a manner, the gas is initially mixed in the mixing room 142, and enters the plasma cavity 112 through the pre-heating pipe 134 to have the ionization reaction.

It should be noted that after passing through the second reforming cavity outlet 122a, the other end of the recirculation pipe 123 can be disposed at any position inside the pre-heating cavity 132. In this embodiment, the other end of the recirculation pipe 123 is disposed near the pre-heating pipe 134 adjacent to the plasma cavity 112, so as to heat the gas inside the pre-heating pipe 134.

After the complicated configuration of the members of the plasma-assisted catalytic reforming apparatus 100 according to the present invention is approximately illustrated, hydrocarbon gas methane is specifically used to illustrate an operation process of the plasma-assisted catalytic reforming apparatus 100. However, in the present invention, the type of the hydrocarbon gas is not limited, and hydrocarbon gas such as ethane, propane, and gas are applicable to the present invention.

In the reforming reaction with the catalyst, if the hydrocarbon gas needs to be reformed into expected hydrogen or carbon monoxide, a temperature of the catalyst has to be higher than a work temperature, and the hydrocarbon gas can only be converted into the hydrogen or carbon monoxide through partial oxidation reforming reaction (incomplete combustion). In order to make the temperature of the catalyst higher than the work temperature, in the present invention, the hydrocarbon gas is firstly introduced for complete oxidation reforming reaction (complete combustion), thereby releasing a large amount of heat into the first catalyst bed 125 for the pre-heating process.

When the temperature of the catalyst is higher than the work temperature, the complete oxidation reforming reaction is changed into partial oxidation reforming reaction for the hydrocarbon gas to generate hydrogen. A key condition that decides whether the hydrocarbon gas has partial or complete oxidation reforming reaction is realized by adjusting a ratio between the hydrocarbon gas and the air. Taking the methane as an example, when the ratio between the methane and the air becomes lower, the complete oxidation reforming reaction occurs easily. On the contrary, when the ratio between the methane and the air becomes higher, the partial oxidation reforming reaction occurs easily.

In such a manner, in the present invention, the present invention does not need an auxiliary heater, and can realize complete combustion of the hydrocarbon gas directly to heat the first catalyst bed 125, so that an construction cost is reduced, a volume of the integral equipment is decreased, and risks caused by the auxiliary heater is avoided.

Referring to FIGS. 1A and 1B again, the feeder 140 further includes a first regulating valve 145 and a second regulating valve 146. The first regulating valve 145 and the second regulating valve 146 are connected to the mixing room 142, so as to control flow amounts of air (not shown) and methane (not shown) that enter the mixing room respectively. In this embodiment, in a pre-heating stage, the first regulating valve 145 and the second regulating valve 146 are opened first to mix the air and methane that enter the mixing room 142. A ratio between flow amounts of the air and methane is 20:1 (that is, an oxygen carbon ratio is 4.2:1).

Next, the air and methane enter the plasma cavity 112 along the pre-heating pipe 134 and are activated through a discharge phenomenon inside the plasma cavity 112. Specifically, a part of the air and methane have reactions such as ionization, dissociation, and excitation due to high-energy electron impact of non-thermal plasma, so as to form quasi-neutral mixed gas (not shown) that contains ions, electrons, and free radicals.

The quasi-neutral mixed gas enters the first reforming cavity 121 for complete combustion and a large amount of heat is released to heat the first catalyst bed 125, thereby increasing the temperature of the catalyst in the first catalyst bed 125. Although the maximum heat can be released during complete combustion of the methane, the combustion occurs in a mixed status before the air and methane contact the first catalyst bed 125, so that the heat released from the methane cannot be completely transferred to the first catalyst bed 125 through conduction from a gas phase (air and methane for combustion) to a solid phase (the catalyst).

It should be noted that in this embodiment, the air and methane are mixed first and then introduced to the first catalyst bed 125. However, if the methane and air are imported in the first catalyst bed 125 respectively and the air and methane are then mixed for combustion, although the first catalyst bed 125 is formed of porous catalyst, the porous catalyst still causes incomplete mixing of the methane and air therein, resulting in a problem that the combustion is incomplete.

Generally speaking, the temperature of the first catalyst bed 125 gradually decreases in the areas of the anterior segment, middle segment, and posterior segment of the reforming reaction. When the temperature of the first catalyst bed 125 exceeds a bottom limit in the area of the anterior segment of the reforming reaction, adjustment of the ratio between the methane and air can be started, so that the methane can be progressively adjusted to an incomplete combustion status. Taking the methane as an example, the bottom limit temperature is 550° C., and the ratio between the flow amounts of the air and methane can be adjusted to 11.9:1, 14.76:1 or 9.52:1 (that is, the oxygen carbon ratio is 2.5:1, 3.1:1 or 2:1) respectively, so as to reduce the air to enable a series of incomplete combustion of the methane to different degrees. The released large amount of heat heats the first catalyst bed 125 continuously through conduction from the gas phase to the solid phase.

At this time, as the catalyst temperature in the area of the anterior segment of the reforming reaction already exceeds the bottom limit 550° C., partial oxidation reforming occurs to a small part of oxygen molecules that are not combusted in the air and methane molecules on a surface of the catalyst. As the incomplete combustion occurs on a surface of each catalyst in the area of the anterior segment, the heat released from the partial oxidation reforming is transferred to each single catalyst directly, so that the catalyst temperature in the area of the anterior segment of the reforming reaction increases rapidly.

Next, through the conduction from the solid phase to the solid phase in the first catalyst bed 125, in combination with the heat released from the combustion of the methane and air, temperature rise of other areas in the first catalyst bed 125 may be accelerated, so that the temperature of the first catalyst bed 125 is maintained above the bottom limit 550° C. However, the principle is that the temperature does not exceed a limit value 900° C.

It should be noted that if the whole first catalyst bed 125 is completely heated with the heat generated from the complete combustion of the methane and air, so that the temperature of the first catalyst bed 125 in the areas of the anterior segment, the middle segment, and the posterior segment of the reforming reaction are above the bottom limit 550° C. and at this time the ratio between the methane and air starts to be adjusted for partial combustion, more methane and air are needed and long time is needed.

When the temperature of the first catalyst bed 125 rises and approaches 900° C., that is, the temperature of the first catalyst bed 125 in the areas of the anterior segment, the middle segment, and the posterior segment of the reforming reaction are above the bottom limit 550° C. most of the time, the flow amount ratio between the air and methane can be adjusted again to 9.52:1 or 8.57:1 (that is, the oxygen carbon ratio are 2:1 or 1.8:1, respectively), so as to further reduce the air for incomplete combustion of the methane to different degrees, and release the little heat contained in the methane to maintain the temperature of the first catalyst bed 125 continuously.

As the temperature of the first catalyst bed 125 in the areas of the anterior segment, the middle segment, and the posterior segment of the reforming reaction are mostly higher than the work temperature, stable partial oxidation reforming occurs to a large part of oxygen molecules in the air and the methane molecules at most of the single catalyst surfaces in the first catalyst bed 125. The released heat is directly transferred to each single catalyst to maintain the temperature of the first catalyst bed 125, so that the temperature of the first catalyst bed 125 is maintained between 550° C. and 900° C.

That is to say, in the plasma-assisted catalytic reforming apparatus 100 according to the present invention, pre-heaters that consume a large amount of fuel are not needed, and the work temperature of the first catalyst bed 125 can be increased rapidly by adjusting only the flow amount ratio between the air and methane. Thus, the plasma-assisted catalytic reforming apparatus 100 can complete the pre-heating (pre-heating the catalyst bed) procedure to realize normal operation in a rapid and cost effective manner.

After the pre-heating procedure is completed, the process of the normal operation is illustrated below. Referring to FIGS. 1A and 1B again, similar to the above, the first regulating valve 145 and the second regulating valve 146 are first adjusted to enable the air and methane to enter the mixing room 142 to be mixed at the above ratio. The flow amount ratio between the air and methane can be a ratio of 9.52:1 or 8.57:1 (that is, an oxygen carbon ratio is 2:1 or 1.8:1 respectively) to realize incomplete combustion.

Next, the air and methane enter the pre-heating pipe 134 to be heated (the process of being heated by residual heat is illustrated in detail below), enter the plasma cavity 112 along the pre-heating pipe 134, and form quasi-neutral mixed gas (not shown) that contains ions, electrons, and free radicals through a discharge phenomenon inside the plasma cavity 112. In this embodiment, the pre-heating pipe 134 is connected to the plasma cavity inlet 112a in a direction, for example, of deviating from the center of the plasma cavity 112, so that the air and methane enter the plasma cavity 112 and then flow in a vortex mode surrounding the plasma electrode 114, thereby mixing the air and methane more evenly and activating them into the quasi-neutral mixed gas.

Further, the quasi-neutral mixed gas enters the first reforming cavity 121. In a situation that the temperature of the first catalyst bed 125 is higher than the work temperature, partial oxidation reforming reaction occurs to the free methane molecules and free oxygen molecules in the quasi-neutral mixed gas on the catalyst surface in the area of the anterior segment in the reforming reaction, so as to gradually generate carbon monoxide, carbon dioxide, hydrogen, and water. At this time, the carbon monoxide, carbon dioxide, hydrogen, and water (in a gaseous state), nitrogen to which no reaction occurs, and methane molecules and oxygen molecules to which the reaction does not occur yet form the high-temperature reaction gas (not shown) in the area of the anterior segment of the reforming reaction of the first catalyst bed 125.

Next, the high-temperature reaction gas enters the second reforming cavity 122 through the first reforming cavity outlet 121b to react continuously. Similar to the above, partial oxidation reforming reaction occurs to the methane molecules and oxygen molecules to which the reaction does not occur yet in the high-temperature reaction gas on the catalyst surface of the areas of the middle segment and posterior segment of the reforming reaction. The methane molecules and oxygen molecules to which the reaction does not occur yet are completely converted into carbon monoxide, carbon dioxide, hydrogen, and water (in a gaseous state) gradually. In such a manner, carbon monoxide, carbon dioxide, hydrogen, water (gaseous state), and the nitrogen to which no reaction occurs in the area of the posterior segment of the reforming reaction in the first catalyst bed 125 form the high-temperature reformed gas (not shown).

It should be noted that the high-temperature reaction gas and the high-temperature reformed gas are only conceptually different, and in the present invention precise positions of them are not particularly differentiated. That is, the high-temperature reaction gas is only a general conceptual term when the partial oxidation reforming process is not completed yet, and the high-temperature reaction gas is only a general conceptual term when the partial oxidation reforming process is completed, which can be readily understood by persons skilled in the art.

Next, the high-temperature reformed gas enters the recirculation pipe 123 through the first reforming cavity opening 121c. In the illustration above, the recirculation pipe 123 is to avoid the problem of flow-short-circuit, so that the quasi-neutral mixed gas can contact most catalyst when passing through the area of the anterior segment of the reforming reaction in the first catalyst bed 125, so as to increase reforming efficiency and greatly reduce the volume of the reforming reactor 120. In addition, the high-temperature reformed gas can absorb the heat in the area of the anterior segment of the reforming reaction of the first catalyst bed 125 and transfer the heat to the middle segment area of the reforming reaction of the first catalyst bed 125, so that the temperature of the first catalyst bed 125 can be evenly distributed, so as to further improve the reaction effect of the whole first catalyst bed 125.

Next, the high-temperature reformed gas enters the pre-heating cavity 132 along the recirculation pipe 123 to heat the air and methane inside the pre-heating pipe 132. The air and methane heated inside the pre-heating pipe 132 enters the plasma cavity 112 and are easily excited and activated. That is, in the present invention only residual temperature of the high-temperature reformed gas is utilized to heat the air and methane, and no exterior heater is needed, so as to reduce the construction cost and decrease an integral size of the apparatus.

In this embodiment, the other end of the recirculation pipe 123 passes through the second reforming cavity outlet 122a and is disposed near the pre-heating pipe 134 of the adjacent plasma cavity 112, so that the high-temperature reformed gas that just leaves the reforming reactor 120 can directly heat the air and methane that will soon enter the plasma cavity 112. Thus, residual heat of the high-temperature reformed gas exerts a maximum effect. In addition, a part of the pre-heating pipe 134 inside the pre-heating cavity 132, for example, surrounds the reforming reactor 120 in two layers, so as to achieve better effects of absorbing heat of the high-temperature reformed gas and transferring the heat to the outside by the reforming reactor 120. However, in the present invention, the mode in which the pre-heating pipe 134 surrounds the reforming reactor 120 is not limited.

Additionally, the pre-heater 130 encloses the reforming reactor 120, so that the temperature distribution of the plasma-assisted catalytic reforming apparatus 100 decreases gradually from the internal high-temperature reforming reactor 120 to the middle or low-temperature pre-heater 130 in periphery, so as to improve the overall heat utilisation and avoid risks of directly contacting the high-temperature reforming reactor 120.

Finally, the high-temperature reformed gas with the temperature decreased gradually and containing rich hydrogen leaves the pre-heating cavity 132 through the pre-heating cavity outlet 132b, and is delivered to a downstream apparatus, which is further processed for subsequent use in a fuel battery and an internal combustion engine.

Referring to FIGS. 1A and 1B again, in this embodiment, a shape of the recirculation pipe 123 inside the first reforming cavity 121 is a single irregular coil pipe, thereby preventing the quasi-neutral mixed gas from passing through the anterior segment area of the reforming reaction in the first catalyst bed 125 in a shortest path by using obstacles. However, in the present invention, the number and shape of the recirculation pipe 123 is not limited. When a plurality of recirculation pipes 123 exists, a corresponding first reforming cavity opening 121c still needs to be opened in the first reforming cavity 121.

In order to further improve the reforming efficiency of the first catalyst bed 125, in the present invention, a partition plate can be further disposed inside the first reforming cavity 121 or the second reforming cavity 122, which is illustrated below with reference to another embodiment and the accompanying drawings. For ease of illustration, the same names and reference numerals are still used for the members having the same functions.

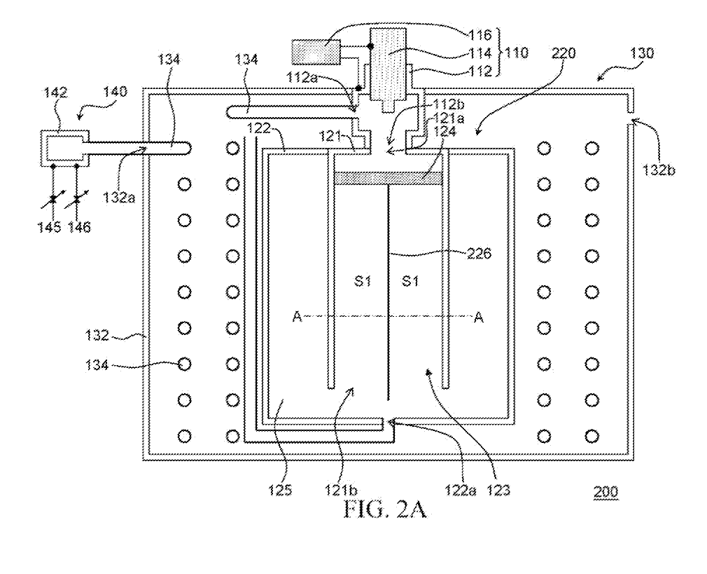

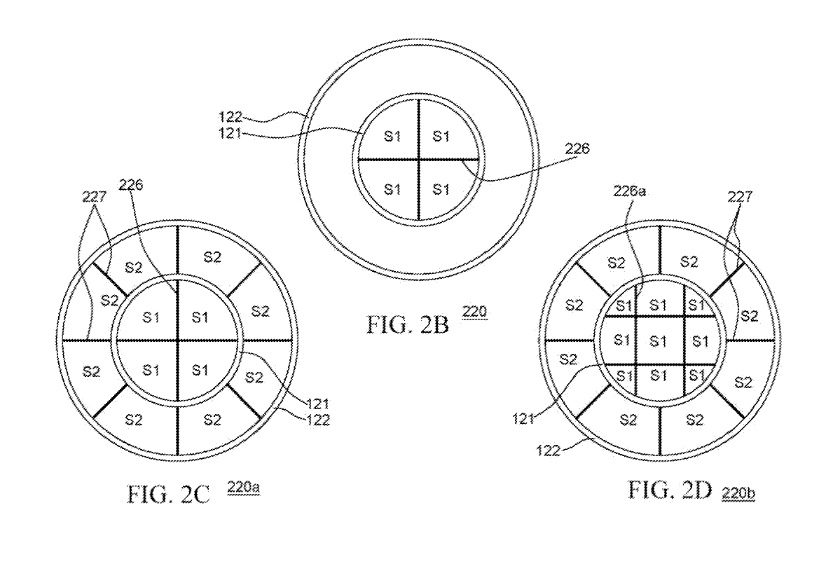

FIG. 2A is a schematic sectional view of a plasma-assisted catalytic reforming apparatus according to another embodiment of the present invention, in which a first catalyst bed, a recirculation pipe, and a first reforming cavity opening are omitted. FIG. 2B is a sectional top view of a reforming reactor in FIG. 2A along line AA. Referring to FIGS. 2A to 2B, in this embodiment, the plasma-assisted catalytic reforming apparatus 200 is similar to the plasma-assisted catalytic reforming apparatus 100 (as shown in FIG. 1A). The only difference is that the reforming reactor 220 of the plasma-assisted catalytic reforming apparatus 200 further includes a first partition plate 226. The first partition plate 226 is disposed inside the first reforming cavity 121, so that the first reforming cavity 121 is divided into a plurality of first reaction zones S1 independent from each other.

In this embodiment, the first partition plate 226, for example, is a cross partition plate to form four first reaction zones S1. A cross section area of each first reaction zone S1 is only one fourth of a cross section area of the original first reforming cavity 121. That is, an equivalent diameter of each first reaction zone S1 is half of an equivalent diameter of the first reforming cavity 121, so that a “length-diameter ratio” of each first reaction zone S1 is twice as much as a “length-diameter ratio” of the original first reforming cavity 121.

When the air flow passes through the area having a large length-diameter ratio rapidly, a fully-developed turbulence easily occurs. Different gas components in the air flow in the turbulence status can achieve complete mixing easily, and pass through the area evenly with a trapezoidal velocity profile, so that the different gas components that are completely mixed fully contact the catalyst in this area. That is, in this embodiment, the completely mixed gas components in the quasi-neutral mixed gas fully contact the catalyst in the first reaction zone S1 and have the reaction on the catalyst surface, thereby improving the reaction effect by fully utilizing the first catalyst bed 125.

Incidentally, in order to enhance the division effect of the first partition plate 226, the number of the recirculation pipes 123 may be the same as the number of the first reaction zones S1, so that a recirculation pipe 123 is disposed in each first reaction zone S1, which can be readily understood by persons skilled in the art, and will not be described in detail here.

FIG. 2C is a sectional top view of a reforming reactor according to another embodiment of the present invention. Similar to the above, the reforming reactor 220a further includes a second partition plate 227. The second partition plate 227 is disposed inside the second reforming cavity 122, so that the second reforming cavity 121 is divided into a plurality of second reaction zones S2 independent from each other. In this embodiment, the number of the second partition plates 227 is for example eight, so that the second reforming cavity 122 is divided into eight symmetrical second reaction zones S2. Similar to the above, the air flow in the second reaction zone S2 can form a fully-developed turbulence easily, so that the completely mixed gas components in the high-temperature reaction gas can fully contact the catalyst in the second reaction zones S2, so as to improve the reaction effect.

Definitely, in the present invention, the number and shape of the first partition plates 226 and second partition plates 227 are not limited, and the shapes of the divided first reaction zones S1 or second reaction zones S2 are not limited. For example, the first partition plate 226a may also be a #-shaped partition plate as shown in the reforming reactor 220b in FIG. 2D.

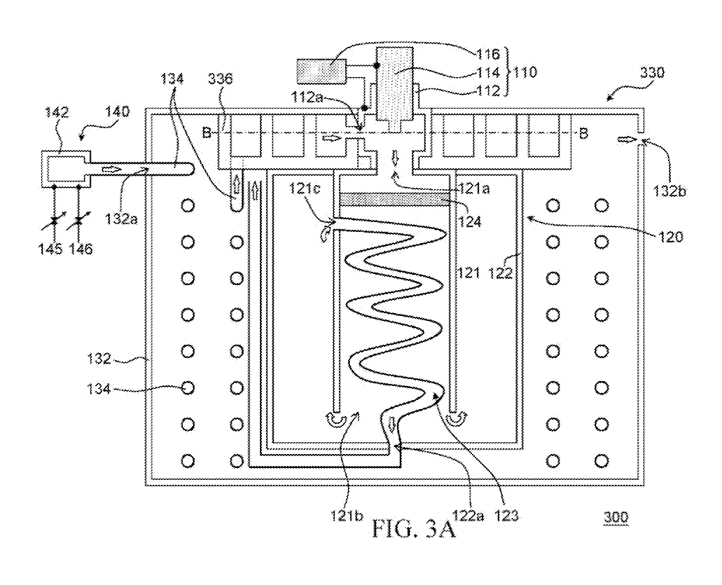

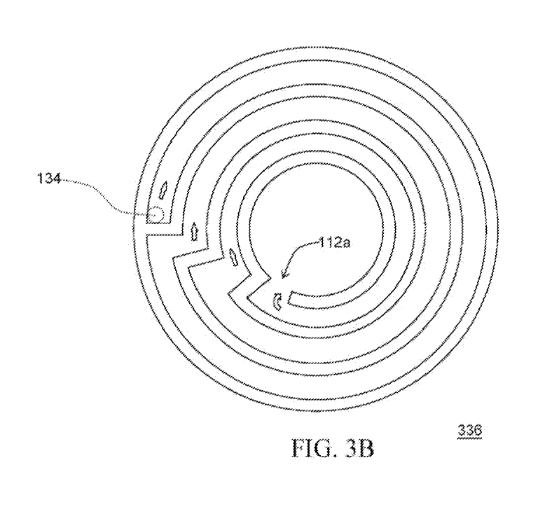

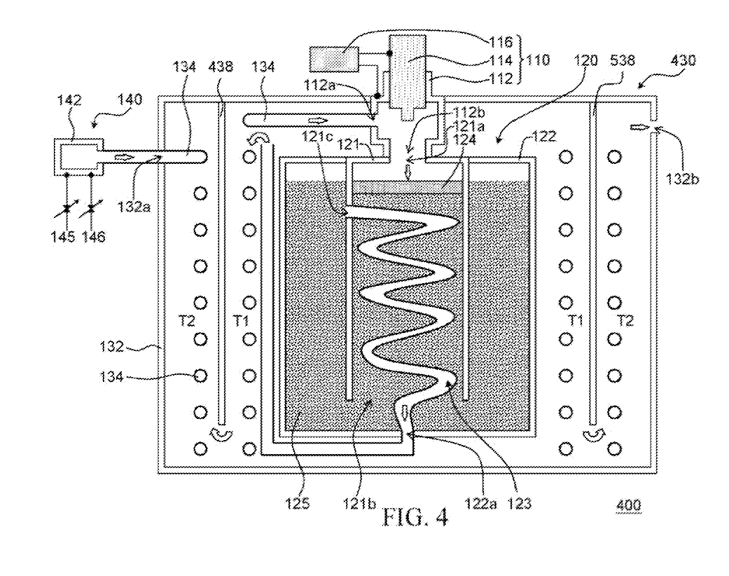

FIG. 3A is a schematic sectional view of a plasma-assisted catalytic reforming apparatus according to another embodiment of the present invention with a first catalyst bed being omitted. FIG. 3B is a sectional top view of a spiral pre-heating channel in FIG. 3A along line BB. Referring to FIGS. 3A and 3B, in this embodiment, the plasma-assisted catalytic reforming apparatus 300 is similar to the plasma-assisted catalytic reforming apparatus 100 (as shown in FIG. 1A). The only difference is that the pre-heater 330 of the plasma-assisted catalytic reforming apparatus 300 further includes a spiral pre-heating channel 336. The spiral pre-heating channel 336 is disposed inside the pre-heating cavity 132 and connected between an end of the pre-heating pipe 134 and the plasma cavity inlet 112a.

Next, the spiral pre-heating channel 336 has an airway surrounding the plasma cavity 112 spirally. The air and methane enter the spiral pre-heating channel 336 through the pre-heating pipe 134, and then circle inwardly along the airway in the spiral pre-heating channel 336, and eventually enter the plasma cavity 112 through the plasma cavity inlet 112a.

As high-voltage discharge occurs inside the plasma cavity 112, the temperature of the plasma cavity 112 is also very high. Through the design of the spiral pre-heating channel 336, the heat in the plasma cavity 112 is transferred outwardly along the spiral pre-heating channel 336, so as to further heat the air and methane inside the spiral pre-heating channel 336. In addition, the heat is absorbed rapidly by the spiral pre-heating channel 336, so the temperatures of the plasma cavity 112 and plasma electrode 114 can be lowered rapidly, so as to extend the life of the plasma reactor 110.

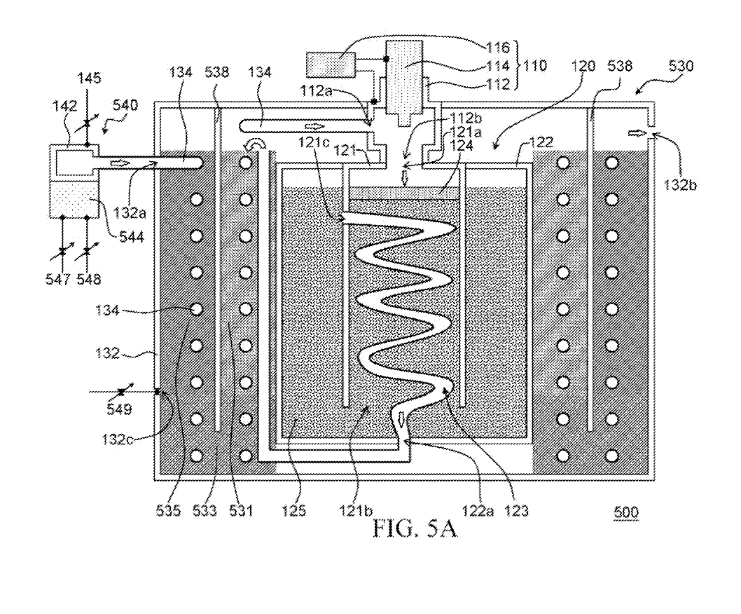

FIG. 4 is a schematic sectional view of a plasma-assisted catalytic reforming apparatus according to another embodiment of the present invention. Referring to FIG. 4, in this embodiment, the plasma-assisted catalytic reforming apparatus 400 is similar to the plasma-assisted catalytic reforming apparatus 100 (as shown in FIG. 1A). The only difference is that the pre-heater 430 of the plasma-assisted catalytic reforming apparatus 400 further includes a third partition plate 438. The third partition plate 438 is disposed inside the pre-heating cavity 132, so as to divide the pre-heating cavity 132 into a first pre-heating area T1 and a second pre-heating area T2 connected to each other. The pre-heating pipe 134 surrounds the reforming reactor 120 in two layers along the first pre-heating area T1 and the second pre-heating area T2. The second pre-heating area T2 is located at the periphery of the first pre-heating area T1.

In such a manner, the high-temperature reformed gas that enters the pre-heating cavity 132 through the recirculation pipe 123 passes through the first pre-heating area T1 and the second pre-heating area T2 in sequence, so that the high-temperature reformed gas transfers heat to the periphery. Generally speaking, the high-temperature reformed gas still has a part of carbon monoxide and the carbon monoxide is toxic for human beings. Therefore, a CO preferential oxidation catalyst can be disposed in the first pre-heating area T1 and the second pre-heating area T2, so as to convert the carbon monoxide into carbon dioxide. Of course, in the present invention, the type of the catalyst in the first pre-heating area T1 and second pre-heating area T2 is not limited. For example, a water-gas shift catalyst can also be disposed in the first pre-heating area T1 and the second pre-heating area T2 to convert the carbon monoxide in the high-temperature reformed gas into carbon dioxide.

It should be noted that in the present invention, the number of areas of the pre-heating cavity 132 divided by the third partition plate 438 is not limited to two. Persons skilled in the art can divide the pre-heating cavity 132 into more than three connected areas according to the above by using a third partition plate 438, which still falls within the scope of the present invention.

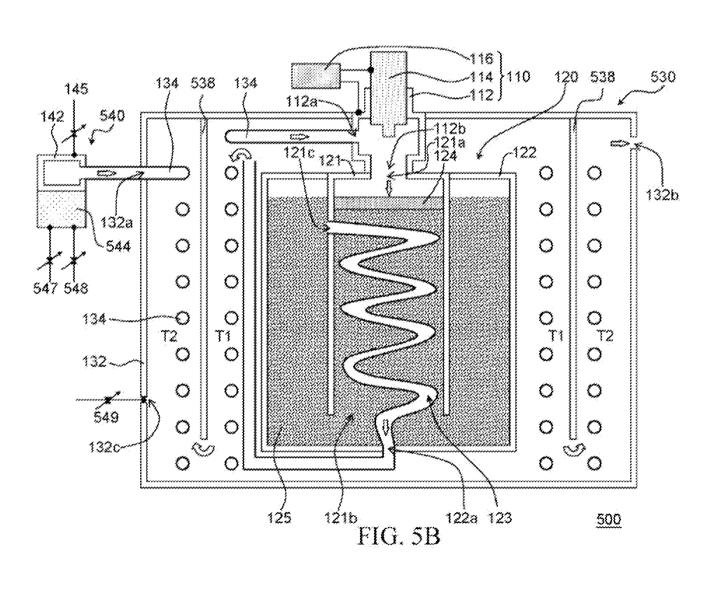

In the discussions above, the hydrocarbon gas is mainly used as an example for illustration of the reforming reaction. The plasma-assisted catalytic reforming apparatus is slightly modified below to be applicable to the reforming reaction of hydrocarbon liquid. FIG. 5A is a schematic sectional view of a plasma-assisted catalytic reforming apparatus according to another embodiment of the present invention. FIG. 5B is a schematic sectional view of the plasma-assisted catalytic reforming apparatus in FIG. 5A with a second catalyst bed, a third catalyst bed, and a fourth catalyst bed being removed. Referring to FIGS. 5A and 5B, in this embodiment, the plasma-assisted catalytic reforming apparatus 500 is similar to the plasma-assisted catalytic reforming apparatus 100 (as shown in FIG. 1A). The only difference is that a feeder 540 of the plasma-assisted catalytic reforming apparatus 500 further includes a piezoelectric atomizer unit 544. The piezoelectric atomizer unit 544 is connected to the mixing room 142. The piezoelectric atomizer unit 544 is used for atomizing the hydrocarbon liquid and water into micro droplets (an average particle diameter is smaller than 10 μm), which are then delivered into the mixing room 142 to mix with the air.

In such a manner, the actions of the micro droplets in the air are basically the same as gas, and the micro droplets enter the plasma cavity 112 through the pre-heating pipe 134 for discharge activation. Specifically, the feeder 540 includes a first regulating valve 145, a third regulating valve 547, and a fourth regulating valve 548. The first regulating valve 145 is connected to the mixing room 142 to control the flow amount of air. The third regulating valve 547 and the fourth regulating valve 548 are connected to the piezoelectric atomizer unit 544, so as to control flow amounts of the hydrocarbon liquid and water, respectively.

Similar to the above, a ratio between the hydrocarbon liquid and the air is suitably adjusted (or an oxygen carbon ratio), so that complete combustion (complete oxidation reforming) or incomplete combustion (incomplete oxidation reforming) occurs to the hydrocarbon liquid. In the pre-heating stage, in this embodiment, the method can be first used to combust and heat the first catalyst bed 125 with the methane (hydrocarbon gas) to a work temperature, and then the hydrocarbon liquid, water, and air are introduced to realize partial oxidation reforming of the hydrocarbon liquid.

Of course, in other embodiments, in the pre-heating stage, the hydrocarbon liquid and air can also be first introduced, and complete combustion of the hydrocarbon liquid is realized through suitable ratio distribution to heat the first catalyst bed 125. Subsequently, the ratio between the hydrocarbon liquid and air is further adjusted progressively, so that the complete combustion of the hydrocarbon liquid is gradually changed into partial combustion. Similar procedures are already illustrated in detail in the pre-heating process of the methane, which can be easily inferred and understood by persons skilled in the art, and will not be described in detail here.

In this embodiment, the hydrocarbon liquid is, for example, the ethanol for illustration. However, in the present invention, the type of the hydrocarbon liquid is not limited. The hydrocarbon liquid may also be liquefied petroleum gas or propanol. Incidentally, a piezoelectric pump or a micro pump can be further connected to the third regulating valve 547 and the fourth regulating valve 548 externally, so as to inject the ethanol and water into the piezoelectric atomizer unit 544. In addition, in the present invention, the number of the piezoelectric atomizer units 544 is not limited. For example, in other embodiments, two piezoelectric atomizer units may also be disposed to atomize the ethanol and the water respectively and deliver the atomized ethanol and water into the mixing room 142 to be mixed.

When a temperature of the first catalyst bed 125 reaches the work temperature and the pre-heating stage is finished, the process of normal operation can be performed. Referring to FIGS. 5A and 5B again, the first regulating valve 145, the third regulating valve 547, and the fourth regulating valve 548 are regulated, so as to deliver the air, the atomized ethanol, and the atomized water into the mixing room 142 to be mixed.

Next, the air, the atomized ethanol, and the atomized water enter the pre-heating pipe 134 to be heated. Similar to the above, at this time, the pre-heating cavity 132 is filled with high-temperature gas. The atomized ethanol and atomized water are heated to form vaporized ethanol and vaporized water. It should be noted that an average particle diameter of the micro droplets is smaller than 10 μm, so that the micro droplets have relatively large surface areas and are vaporized by absorbing heat very easily. Therefore, in this embodiment, the piezoelectric atomizer unit 544 is first used to atomize the ethanol and water.

When the air, the vaporized ethanol, and the vaporized water enter the plasma cavity 112 along the pre-heating pipe 134, quasi-neutral mixed gas (not shown) containing ions, electrons, and free radicals is formed through the discharge inside the plasma cavity 112. Next, the quasi-neutral mixed gas enters the first reforming cavity 121. In a situation that the temperature of the first catalyst bed 125 is higher than the work temperature, partial oxidation reforming reaction occurs to ionized ethanol molecules and ionized oxygen molecules in the quasi-neutral mixed gas on the catalyst surface in the area of the anterior segment of the reforming reaction, so as to generate carbon monoxide, carbon dioxide, and hydrogen and water gradually. At this time, the carbon monoxide, carbon dioxide, hydrogen, water (in a gaseous state), nitrogen to which no reaction occurs, ethanol molecules and oxygen molecules to which the reaction does not occur yet form the high-temperature reaction gas (not shown) in the area of the anterior segment of the reforming reaction of the first catalyst bed 125.

Next, the high-temperature reaction gas enters the second reforming cavity 122 through the first reforming cavity outlet 121b to continue the reaction. Similar to the above, partial oxidation reforming reaction occurs to the ethanol molecules and oxygen molecules to which the reaction does not occur yet in the high-temperature reaction gas on the catalyst surface in the areas of the middle segment and posterior segment of the reforming reaction, so as to completely convert the ethanol molecules and oxygen molecules to which the reaction does not occur into the carbon monoxide, carbon dioxide, hydrogen, and water (in a gaseous state) gradually. In such a manner, the carbon monoxide, carbon dioxide, hydrogen, water (in a gaseous state), and nitrogen to which no reaction occurs in the area of the posterior segment of the reforming reaction of the first catalyst bed 125 form the high-temperature reformed gas (not shown).

The high-temperature reformed gas enters the recirculation pipe 123 through the first reforming cavity opening 121c, so as to enter the pre-heating cavity 132 along the recirculation pipe 123 to heat the air, atomized ethanol, and atomized water inside the pre-heating pipe 132. After entering the plasma cavity 112, the heated air, and the vaporized ethanol and water inside the pre-heating pipe 132 are easily excited and activated.

Similar to the above, in order to further increase the content of the hydrogen in the high-temperature reformed gas or decrease the content of carbon monoxide in the high-temperature reformed gas, in this embodiment, a catalyst can be further disposed in the pre-heating cavity 132, so that the high-temperature reformed gas has reaction again.

Referring to FIGS. 5A and 5B again, in this embodiment, a pre-heater 530 of the plasma-assisted catalytic reforming apparatus 500 further includes a third partition plate 538. The third partition plate 538 is disposed inside the pre-heating cavity 132, so as to divide the pre-heating cavity 132 into a first pre-heating area T1 and a second pre-heating area T2 connected to each other. The pre-heating pipe 134 is surrounds the reforming reactor 120 in two layers along the first pre-heating area T1 and the second pre-heating area T2. The second pre-heating area T2 is located at the periphery of the first pre-heating area T1.

In addition, the pre-heater 530 can further include a second catalyst bed 531, a third catalyst bed 533, and a fourth catalyst bed 535. The second catalyst bed 531 can be disposed inside the first pre-heating area T1. The third catalyst bed 533 can be disposed at a border of the first pre-heating area T1 and the second pre-heating area T2. The fourth catalyst bed 535 can be disposed inside the second pre-heating area T2. In this embodiment, the second catalyst bed 531 can have a high-temperature water-gas shift catalyst, the third catalyst bed 533 can have a low-temperature water-gas shift catalyst, and the fourth catalyst bed 535 can have a CO preferential oxidation catalyst.

In such a manner, the high-temperature reformed gas that enters the pre-heating cavity 132 through the recirculation pipe 123 passes through the first pre-heating area T1 and the second pre-heating area T2 gradually, and has reaction with the second catalyst bed 531, the third catalyst bed 533, and the fourth catalyst bed 535 in sequence. In the second catalyst bed 531 and the third catalyst bed 533, a water-gas shift reaction occurs to the vaporized water molecules and carbon monoxide in the high-temperature reformed gas on surfaces of the high-temperature water-gas shift catalyst and low-temperature water-gas shift catalyst, so as to generate hydrogen and carbon dioxide, thereby increasing the content of hydrogen and decrease the content of carbon monoxide at the same time.

In addition, the water-gas shift reaction is an exothermic process, so the released heat can be further transferred to the pre-heating pipe 134, so as to heat the air in the pre-heating pipe 134 and heat the atomized ethanol and water to form vaporized ethanol and water, thereby increasing whole heat utilization of the plasma-assisted catalytic reforming apparatus 500.

It should be noted that after the high-temperature reformed gas passes through the high-temperature water-gas shift catalyst in the second catalyst bed 531, if concentration of the carbon monoxide in the high-temperature reformed gas can be decreased to about 2% (Vol.), in this embodiment, the low-temperature water-gas shift catalyst in the third catalyst bed 533 can also be omitted, so as to decrease the construction cost of the plasma-assisted catalytic reforming apparatus 500.

After passing through the second catalyst bed 531 and the third catalyst bed 533, the high-temperature reformed gas usually still has carbon monoxide with concentration of about 2% (Vol.), and forms middle-temperature reformed gas (not shown) as the temperature gradually decreases. In the fourth catalyst bed 535, oxidation reforming occurs to the residual carbon monoxide molecules and oxygen molecules in the middle-temperature reformed gas on a surface of the CO preferential oxidation catalyst, so as to form the carbon dioxide and release heat to heat the pre-heating pipe 134, thereby increasing the whole heat utilization of the plasma-assisted catalytic reforming apparatus 500.

After passing through the fourth catalyst bed 535, the middle-temperature reformed gas forms the low-temperature reformed gas as the temperature gradually decreases. The low-temperature reformed gas is rich in hydrogen fuel and contains almost no residual carbon monoxide that is harmful to human bodies. Finally, the low-temperature reformed gas leaves the pre-heating cavity 132 through the pre-heating cavity outlet 132b, and is delivered to a downstream apparatus to serve as fuel.

It should be noted that the high-temperature reformed gas, middle-temperature reformed gas, and low-temperature reformed gas are only conceptually different and precise positions thereof are not specifically differentiated in the present invention. That is, the high-temperature, middle-temperature, or low-temperature reformed gas is only staged terms for ease of illustrating the concept of converting carbon monoxide into hydrogen or removing the residual carbon monoxide, which is readily apparent and distinguishable for persons skilled in the art.

In addition, the carbon monoxide is also a type of fuel. If the carbon monoxide does not need to be removed, the second catalyst bed 531, the third catalyst bed 533, and the fourth catalyst bed 535 are not needed, and the high-temperature reformed gas is directly collected at the pre-heating cavity outlet 132b.

The ethanol is also a type of biomass fuel, which can reduce the emission of carbon dioxide. As plants are made into the biomass fuel such as ethanol after absorbing carbon atoms from the environment, the combustion of the biomass fuel such as the ethanol is only a carbon atom cycle in the environment of the earth, and the total amount of the carbon dioxide in the air environment of the earth is not increased, so that the objective of environmental protection is achieved.

Referring to FIGS. 5A and 5B again, in order to increase the reaction efficiency of the middle-temperature reformed gas in the fourth catalyst bed 535 to completely remove the residual carbon monoxide, in this embodiment, the pre-heating cavity 132 further has a pre-heating cavity opening 132c, so that the air enters the pre-heating cavity 132 through the pre-heating cavity opening 132c, and oxidation reforming occurs to oxygen molecules in the air and the residual carbon monoxide on the surface of the CO preferential oxidation catalyst. Definitely, the feeder 540 may further include a fifth regulating valve 549. The fifth regulating valve 549 is connected to the pre-heating cavity opening 132c to regulate a flow amount of the air, which can be readily understood by persons skilled in the art, and will not be described in detail here.

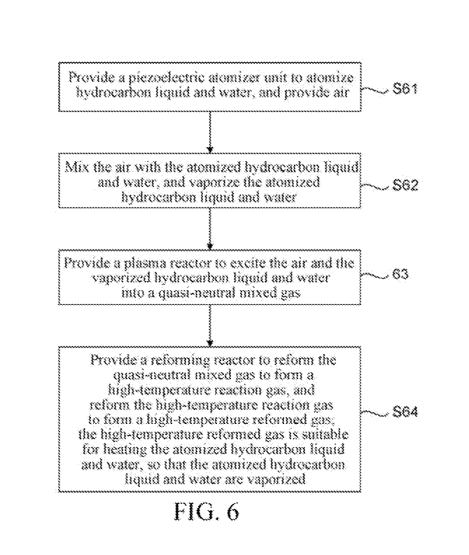

Although the plasma-assisted catalytic reforming method of the present invention has been illustrated in detail above at the same time, in order to make the method more comprehensible, the plasma-assisted catalytic reforming method is illustrated below with reference to the accompanying drawings. FIG. 6 is a schematic flow chart of a plasma-assisted catalytic reforming method according to an embodiment of the present invention. Referring to FIG. 6, as shown in Steps S61 to S64, a piezoelectric atomizer unit is provided firstly to atomize the hydrocarbon liquid and water, and air is provided, and then the air and the atomized hydrocarbon liquid and water are mixed in the mixing room.

Next, in the pre-heating pipe, the atomized hydrocarbon liquid and water are vaporized by heating, so as to form vaporized hydrocarbon liquid and water. Next, the plasma reactor excites the air and the vaporized hydrocarbon liquid and water into a quasi-neutral mixed gas, the reforming reactor then reforms the quasi-neutral mixed gas to form a high-temperature reaction gas, and the high-temperature reaction gas is subsequently reformed to form a high-temperature reformed gas. The high-temperature reformed gas is suitable for heating the atomized hydrocarbon liquid and water, so as to vaporize the atomized hydrocarbon liquid and water.

In conclusion, the plasma-assisted catalytic reforming apparatus and method of the present invention at least have the following advantages.

1. The recirculation pipe can avoid the flow-short-circuit problem, so as to greatly improve the reaction efficiency of the gas and catalyst, and further decrease a volume of the reforming reactor to reduce the manufacturing cost. In addition, when the high-temperature reformed gas flows into the recirculation pipe, the heat in the area of the anterior segment of the reforming reaction is brought to the area of the middle segment of the reforming reaction, so as to improve evenness of the temperature of the first catalyst bed and further increase the reforming efficiency.

2. By adjusting the flow amount of the hydrocarbon gas (or hydrocarbon liquid) relative to the air, the hydrocarbon gas realizes complete combustion to heat the first catalyst bed, so that the temperature of the first catalyst bed reaches a work temperature to complete a pre-heating procedure. Therefore, in the present invention, no auxiliary heater is needed, thereby decreasing the construction cost, reducing the overall equipment volume, and avoiding risks caused by the auxiliary heater.

3. The pre-heating pipe is disposed to utilise the residual heat of the high-temperature reformed gas to heat the air, hydrocarbon gas, atomized hydrocarbon liquid or atomized water inside the pre-heating pipe, so as to improve the effect of excitation and activation. As no exterior heater is needed to pre-heat the air, hydrocarbon gas, atomized hydrocarbon liquid or atomized water, the construction cost can be reduced and an overall size of the apparatus can be decreased.

4. The pre-heater encloses the reforming reactor, so that the temperature distribution in the plasma-assisted catalytic reforming apparatus is that the temperature gradually decreases from the interior high-temperature reforming reactor to the middle and low-temperature pre-heaters in periphery, so as to improve the overall heat utilization and avoid risks of directly contacting the high-temperature reforming reactor.

5. By disposing the first partition plate and second partition plate, the gas can form fully-developed turbulence, so as to further improve the conversion efficiency of the catalytic reforming.

6. By disposing the spiral pre-heating channel, the heat in the plasma cavity can be absorbed to extend the life of the plasma reactor.

7. The high-temperature reformed gas have the reforming reaction by using the second catalyst bed, the third catalyst bed, and the fourth catalyst bed. In addition to increasing the content of hydrogen and decreasing the content of carbon monoxide, the heat released from the reforming reaction can heat the gas or atomized liquid inside the pre-heating pipe at the same time, thereby improving the overall heat utilization.

8. When the ethanol is used as the hydrocarbon liquid to produce hydrogen fuel, as the total amount of carbon dioxide in the air environment of the earth is not increased, the objective of environmental protection is achieved.

The present invention has been disclosed through preferred embodiments, but is not intended to be limited thereto. Various variations and modifications made by persons skilled in the art without departing from the spirit and scope of the present invention fall within the protection scope of the present invention as defined by the appended claims.

What is claimed is:

1. A plasma-assisted catalytic reforming apparatus, comprising:
a feeder, having a mixing room;
a plasma reactor, comprising:
a plasma cavity, having a plasma cavity inlet and a plasma cavity outlet;
a plasma electrode; and
a plasma power supply unit, coupled to the plasma cavity and the plasma electrode, so as to generate discharge inside the plasma cavity;
a reforming reactor, connected to the plasma reactor, comprising:
a first reforming cavity, having a first reforming cavity inlet, a first reforming cavity outlet, and a first reforming cavity opening, wherein the first reforming cavity inlet is connected to the plasma cavity outlet;
a second reforming cavity, wherein the first reforming cavity is disposed inside the second reforming cavity, and the second reforming cavity has a second reforming cavity outlet;
a recirculation pipe, partially disposed inside the first reforming cavity, wherein an end of the recirculation pipe is connected to the first reforming cavity opening, and another end of the recirculation pipe passes through the second reforming cavity outlet through the first reforming cavity outlet;
a porous plate, disposed inside the first reforming cavity and adjacent to the first reforming cavity inlet; and
a first catalyst bed, disposed inside the first reforming cavity and the second reforming cavity; and
a pre-heater, comprising:
a pre-heating cavity, wherein the reforming reactor is disposed inside the pre-heating cavity, and the pre-heating cavity has a pre-heating cavity inlet and a pre-heating cavity outlet; and
a pre-heating pipe, disposed inside the pre-heating cavity, and surrounding the reforming reactor, wherein an end of the pre-heating pipe is connected to the plasma cavity inlet, and another end of the pre-heating pipe passes through the pre-heating cavity inlet to be connected to the mixing room.

2. The plasma-assisted catalytic reforming apparatus according to claim 1, wherein air and hydrocarbon gas are mixed in the mixing room and enter the plasma cavity along the pre-heating pipe to become a quasi-neutral mixed gas, the quasi-neutral mixed gas enters the first reforming cavity to be reformed in the first catalyst bed to form a high-temperature reaction gas, the high-temperature reaction gas enters the second reforming cavity through the first reforming cavity outlet to be reformed in the first catalyst bed to form a high-temperature reformed gas, and the high-temperature reformed gas enters the recirculation pipe through the first reforming cavity opening, enters the pre-heating cavity along the recirculation pipe to heat the air and the hydrocarbon gas inside the pre-heating pipe, and leaves the pre-heating cavity through the pre-heating cavity outlet.

3. The plasma-assisted catalytic reforming apparatus according to claim 1, wherein the feeder further comprises a first regulating valve and a second regulating valve, and the first regulating valve and the second regulating valve are connected to the mixing room, so as to control flow amounts of air and hydrocarbon gas entering the mixing room respectively.

4. The plasma-assisted catalytic reforming apparatus according to claim 1, wherein a portion of the recirculation pipe inside the first reforming cavity is a coil pipe.

5. The plasma-assisted catalytic reforming apparatus according to claim 1, wherein an end of the pre-heating pipe is connected to the plasma cavity inlet in a direction of deviating from a center of the plasma cavity.

6. The plasma-assisted catalytic reforming apparatus according to claim 1, wherein the pre-heater further comprises a spiral pre-heating channel, disposed inside the pre-heating cavity, and connected between an end of the pre-heating pipe and the plasma cavity inlet.

7. The plasma-assisted catalytic reforming apparatus according to claim 1, wherein the reforming reactor further comprises a first partition plate, disposed inside the first reforming cavity.

8. The plasma-assisted catalytic reforming apparatus according to claim 7, wherein the first partition plate is a cross partition plate or a #-shaped partition plate.

9. The plasma-assisted catalytic reforming apparatus according to claim 1, wherein the reforming reactor further comprises a second partition plate, disposed inside the second reforming cavity.

10. The plasma-assisted catalytic reforming apparatus according to claim 1, wherein the pre-heater further comprises a third partition plate, disposed inside the pre-heating cavity, and used for dividing the pre-heating cavity into a first pre-heating area and a second pre-heating area connected to each other.

11. The plasma-assisted catalytic reforming apparatus according to claim 10, wherein the pre-heating pipe surrounds the reforming reactor in two layers along the first pre-heating area and the second pre-heating area.

12. The plasma-assisted catalytic reforming apparatus according to claim 10, wherein the pre-heater further comprises a second catalyst bed, a third catalyst bed, and a fourth catalyst bed, the second catalyst bed is disposed inside the first pre-heating area, the third catalyst bed is disposed at a border between the first pre-heating area and the second pre-heating area, and the fourth catalyst bed is disposed inside the second pre-heating area.

13. The plasma-assisted catalytic reforming apparatus according to claim 12, wherein the second catalyst bed comprises a high-temperature water-gas shift catalyst, the third catalyst bed comprises a low-temperature water-gas shift catalyst, and the fourth catalyst bed comprises a carbon monoxide (CO) preferential oxidation catalyst.

14. The plasma-assisted catalytic reforming apparatus according to claim 1, wherein the feeder further comprises a piezoelectric atomizer unit connected to the mixing room.

15. The plasma-assisted catalytic reforming apparatus according to claim 14, wherein hydrocarbon liquid and water form atomized hydrocarbon liquid and water inside the piezoelectric atomizer unit to enter the mixing room, the atomized hydrocarbon liquid and water enter the pre-heating pipe after being mixed with air entering the mixing room, the atomized hydrocarbon liquid and water form vaporized hydrocarbon liquid and water inside the pre-heating pipe, the vaporized hydrocarbon liquid and water enter the plasma cavity along the pre-heating pipe together with the air to become a quasi-neutral mixed gas, the quasi-neutral mixed gas enters the first reforming cavity to be reformed in the first catalyst bed to form a high-temperature reaction gas, the high-temperature reaction gas enters the second reforming cavity through the first reforming cavity outlet to be reformed in the first catalyst bed to form a high-temperature reformed gas, and the high-temperature reformed gas enters the recirculation pipe through the first reforming cavity opening, enters the pre-heating cavity along the recirculation pipe to heat the air, the atomized hydrocarbon liquid, and the atomized water inside the pre-heating pipe, and leaves pre-heating cavity through the pre-heating cavity outlet.

16. The plasma-assisted catalytic reforming apparatus according to claim 15, wherein the hydrocarbon liquid is ethanol or liquefied petroleum gas.

17. The plasma-assisted catalytic reforming apparatus according to claim 14, wherein the feeder further comprises a first regulating valve, a third regulating valve, and a fourth regulating valve, wherein the first regulating valve is connected to the mixing room to control a flow amount of air entering the mixing room, and the third regulating valve and the fourth regulating valve are connected to the piezoelectric atomizer unit to control flow amounts of hydrocarbon liquid and water entering the piezoelectric atomizer unit respectively.

18. The plasma-assisted catalytic reforming apparatus according to claim 14, wherein the pre-heating cavity further has a pre-heating cavity opening, so that air enters the pre-heating cavity through the pre-heating cavity opening.

19. The plasma-assisted catalytic reforming apparatus according to claim 18, wherein the feeder further comprises a fifth regulating valve, and the fifth regulating valve is connected to the pre-heating cavity opening to control a flow amount of the air.

20. A plasma-assisted catalytic reforming method, comprising:
providing a piezoelectric atomizer unit, for atomizing hydrocarbon liquid and water;
providing air;
mixing the air with the atomized hydrocarbon liquid and water, and vaporizing the atomized hydrocarbon liquid and water;
providing a plasma reactor, for exciting the air and the vaporized hydrocarbon liquid and water into a quasi-neutral mixed gas; and
providing a reforming reactor, for reforming the quasi-neutral mixed gas to form a high-temperature reaction gas, and reforming the high-temperature reaction gas to form a high-temperature reformed gas, wherein the high-temperature reformed gas is suitable for heating the atomized hydrocarbon liquid and water, so that the atomized hydrocarbon liquid and water are vaporized.

21. The plasma-assisted catalytic reforming method according to claim 20, wherein the hydrocarbon liquid is ethanol or liquefied petroleum gas.
